(19) United States
(12) Patent Application Publication
(10) Pub. No.: US 2007/0258003 A1
(43) Pub. Date: Nov. 8, 2007

(54) Imaging subsystem employing dual shift registers

(76) Inventors: Kevin Nay, Fort Collins, CO (US); David K. Campbell, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/417,377

(22) Filed: May 4, 2006

(51) Int. Cl. H04N 3/14; H04N 5/335

(52) U.S. Cl. 348/311

(57) ABSTRACT

An imaging subsystem is provided which includes imaging pixels arranged in rows and columns of an array. Each imaging pixel is configured to generate pixel data corresponding to a portion of an image and transfer the pixel data toward a first end or a second end of its column. Also included is a first shift register configured to receive the pixel data from the first end of the columns and shift the pixel data toward a first direction associated with a first of the columns. A second shift register is configured to receive the pixel data from the second end of the columns and shift the pixel data toward the first direction.

### BACKGROUND

Recent advances in digital imaging technology have made consumer electronic devices such as digital still cameras, digital video cameras, digital image scanners and the like more accessible to a greater number of consumers. As a result, for each such type of device, a significant number of manufacturers typically compete to produce equipment exhibiting a combination of price, performance, and functionality most appealing to potential customers.

Many of these imaging devices employ some type of two-dimensional photosensitive cell (or photocell) array to capture one or more images of interest to a user of the device. One example of a photocell array is included in a charge coupled device (CCD). A CCD typically contains thousands or millions of photocells or picture elements (“pixels”), each of which accumulates an electrical charge proportional to the intensity of light incident upon the pixel. Thereafter, each of these electrical charges is retrieved in a serial fashion and converted to a number indicative of the light intensity. Collectively, the numbers associated with each pixel thus represent an image as received by the CCD.

To yield a useful image, a lens similar to that utilized in legacy photographic film cameras is employed to focus the light received by the device onto the CCD or other photocell array. Typically, the lens used is an inversion lens, which inverts the light received by the lens prior to projecting the light onto the array, resulting in an inverted image. Based on this structure, the CCD and surrounding circuitry are organized so that the charge accumulated by each pixel is read in an order beginning with the upper-left corner of the image, and then proceeding from left to right across each row of pixels, one row at a time, ending at the lower-right corner of the image. This order is normally compatible with displaying the image on a display, printing the image, and so forth.

Recently, some digital imaging devices have begun employing reflection or mirror lenses in lieu of simple inversion lenses. Reflection lenses normally employ one or more mirrors to bend or fold the path of the received light within the device before encountering the CCD. Reflection lenses are often utilized to increase the effective focal length of the lens, resulting in the ability to provide telephoto, or magnification, capability, while maintaining a small form factor for the imaging device.

However, due to the changes in the light path caused by a reflection lens, the orientation of the image is often different from that created by an inversion lens. As a result, the CCD or other photocell array may retrieve the accumulated charge from each pixel in an order different from that typically expected. For example, the image may be retrieved beginning with the upper-right or lower-left corner, as opposed to the upper-left corner, thus complicating further display or printing of the image. While the image may be processed to yield the more standard pixel order, such processing requires significant bandwidth and other resources of the device that could be more advantageously employed performing other tasks.

### BRIEF DESCRIPTION OF THE DRAWINGS

FIG. 1 is a block diagram of an imaging subsystem according to an embodiment of the invention.

FIG. 2 is a flow diagram of a method of supplying an imaging subsystem for an imaging device according to an embodiment of the invention.

FIG. 3 is a simplified representation of an image to be captured by an imaging subsystem according to an embodiment of the invention.

FIG. 4 is a block diagram of an imaging subsystem according to an embodiment of the invention in which the captured image of FIG. 3 is inverted.

FIG. 5 is a block diagram of an imaging subsystem according to an embodiment of the invention in which the captured image of FIG. 3 is inverted and reflected.

FIG. 6 is a block diagram of an imaging subsystem according to an embodiment of the invention in which the captured image of FIG. 3 is reflected.

FIG. 7 is a block diagram of an imaging subsystem according to an embodiment of the invention in which the captured image of FIG. 3 is neither inverted nor reflected.

### DETAILED DESCRIPTION

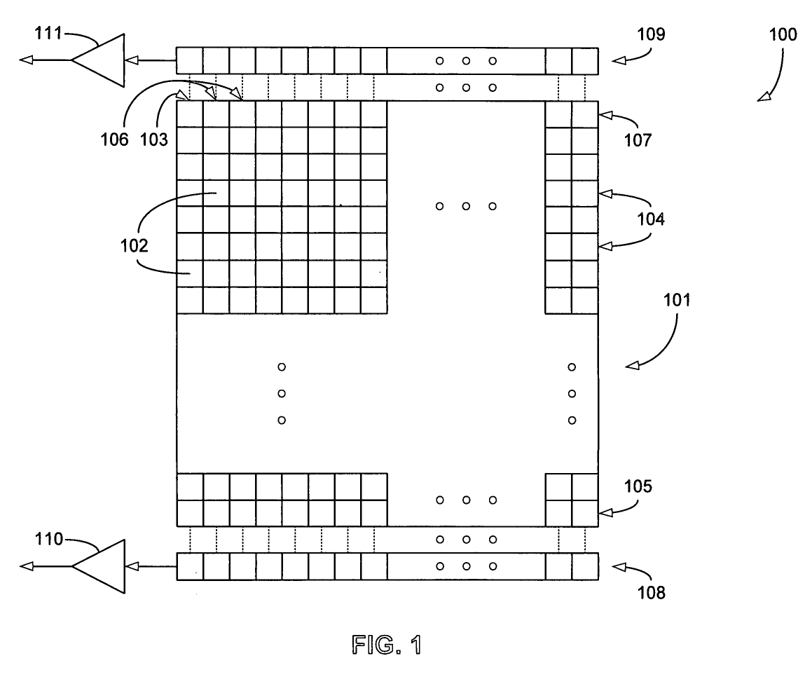

FIG. 1 provides a block diagram of an imaging subsystem 100 according to an embodiment of the invention. Generally, a plurality of imaging pixels 102 are arranged in an array 1001 and organized in rows 104 and columns 106. Each of the imaging pixels 102 is configured to generate pixel data corresponding to a portion of an image. Each pixel 102 is also configured to transfer the pixel data toward a first end 105 or a second end 107 of its column 106.

Also included are a first shift register 108 and a second shift register 109. The first shift register 108 is configured to receive pixel data from the first end 105 of the columns and shift the pixel data toward a first direction associated with a first column 103 of the columns 106. The second shift register 109 is configured to receive the pixel data from the second end 107 of the columns 106, and to shift the pixel data toward the first direction. In the particular example of FIG. 1, the first direction is to the left.

As will be described in greater detail below, various embodiments of the invention may be employed to supply an imaging device with an imaging subsystem that allows the use of any of multiple lens configurations while delivering the pixel data to the device in a consistent order.

In one embodiment, the imaging subsystem 100 may also include a first amplifier 110 configured to amplify the pixel data shifted from the first shift register 108, and a second amplifier 111 configured to amplify the pixel data shifted from the second shift register 109. This amplification may allow other portions of the imaging device to more readily process the pixel data describing the captured image.

In another implementation, the array 101 is a CCD array, wherein the imaging pixels 102 are photocells. As a result, the pixel data of each of the imaging pixels 102 is an electrical charge related to an intensity of light received by the imaging pixel 102. This charge is the pixel data representing a portion of an image being captured by the imaging device. In other embodiments, other arrays of imaging pixels employing a different technology may be used to collect and image visible light. Technologies for detecting infrared frequencies, ultraviolet frequencies, and other portions of the non-visible electromagnetic spectrum may be utilized in yet other embodiments.

While single imaging pixels 102, each related to a particular portion of an image, are discussed herein, such a discussion does not preclude embodiments which employ arrays 101 in which multiple pixels 102 are associated with a particular area of the image. For example, color CCDs often employ at least three pixels, each sensitive to a particular color, such as red, blue or green, for each identifiable portion of an image.

In some implementations, the number of imaging pixels 102 in the array 101 may number in the thousands or millions. In other embodiments, fewer or more imaging pixels may be utilized, depending on the desired level of resolution for the corresponding imaging device.

The imaging subsystem 100 may be employed in a variety of imaging devices, including but not limited to digital still cameras, digital video cameras, and digital image scanners. Also, any device designed to capture images, but whose primary function is not image-related, such as a cell phone, may benefit from application of the various embodiments described herein.

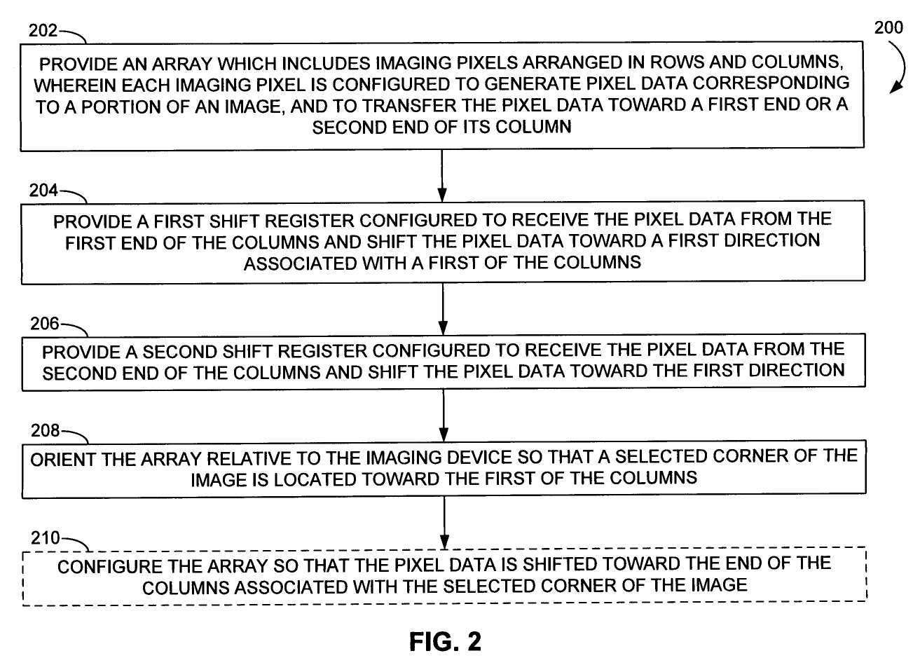

Shown in FIG. 2 is a flow diagram of a method 200 for supplying an imaging subsystem, such as the subsystem 100 of FIG. 1, for an imaging device. An array is provided which includes imaging pixels arranged in rows and columns, wherein each imaging pixel is configured to generate pixel data corresponding to a portion of an image, and to transfer the pixel data toward a first end or a second end of its column (operation 202). Also provided is a first shift register configured to receive the pixel data from the first end of the columns and shift the pixel data toward a first direction associated with a first of the columns (operation 204). Similarly, a second shift register is provided which is configured to receive the pixel data from the second end of the columns and shift the pixel data toward the first direction (operation 206). The array is oriented relative to the imaging device so that a selected corner of the image is located toward the first of the columns (operation 208). In one embodiment, the array is configured so that the pixel data is shifted toward the end of the columns associated with the selected corner of the image (operation 210).

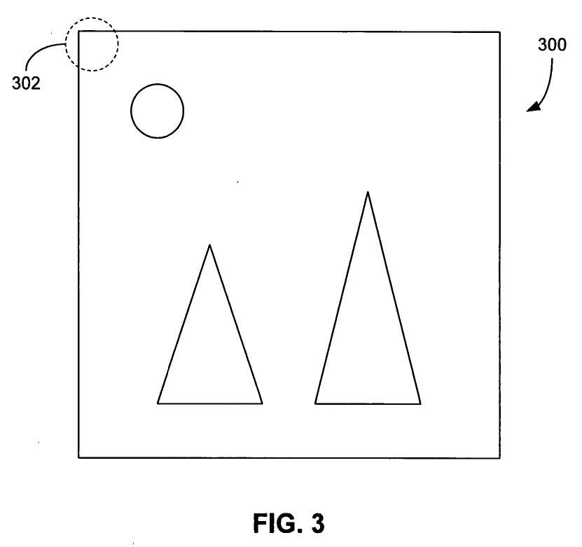

Generally, the imaging device itself provides the frame of reference by which the various portions of the image are identified. For example, with respect to a digital still camera or a digital video camera, how a user of a device views the image by way of a standard view finder or a liquid crystal display (LCD) incorporated into the device typically determines how the image is received into the device. Thus, the upper-left corner of the image as viewed by the user, and as shown in FIG. 3, may be the upper-left corner of the image for purposes of the embodiments described. In one embodiment, the selected corner of the image is the upper-left corner of the image. As a result of this selection in conjunction with the method 200, the imaging device will first transfer pixel data representing the upper-left corner of the image to the imaging device for further processing, display, and the like. In this case, transfer of the pixel data then proceeds along the first row toward the right, then continues at the left of the next row, proceeding in this fashion row by row, ending at the lower-right portion of the image. This transfer order is most ordinarily employed in many imaging devices to allow further processing of the image for eventual use by, or display to, a consumer.

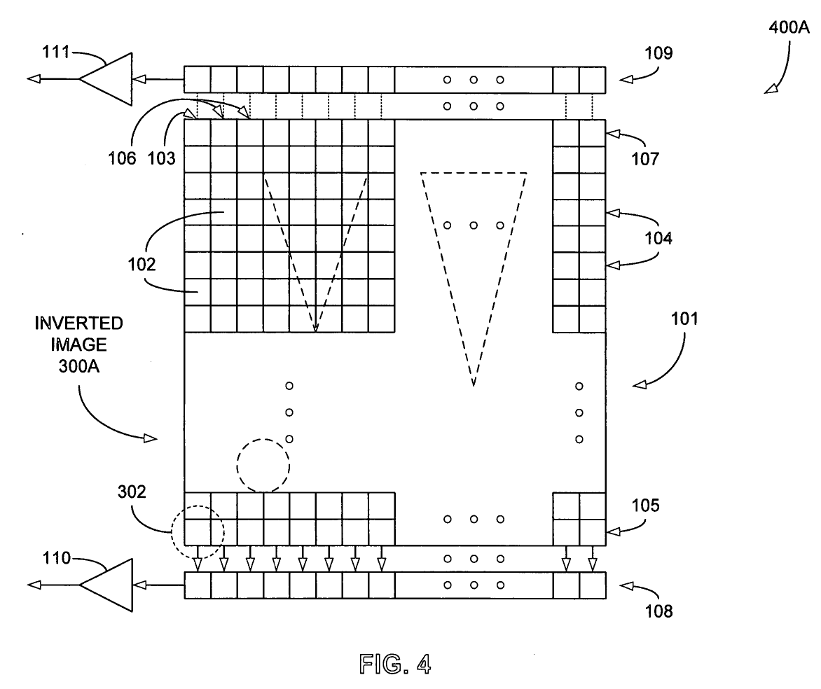

To more fully explain the foregoing embodiments, FIG. 3 provides a simple drawing of a possible image 300 to be captured by an imaging device in the examples provided below. Of particular note is an upper-left corner 302 of the image, which in the embodiments described below is desired to be the first pixel data to be transferred from the imaging subsystem 100, as shown in FIGS. 4-7. In each example, the upper-left corner 302 appears in a different corner of the array 101 as shown in each of the figures, thus describing each of the four possible orientations of the image 300 as captured by the imaging subsystem 100 in relation to the imaging device. In other embodiments, a portion of the image 300 other than the upper-left corner 302 may be selected as the first area of the image 300 to be transferred to the remainder of the imaging device.

In a first example depicted in FIG. 4, the imaging subsystem 100 is placed in a first configuration 400A for capturing an inverted image 300A (i.e., swapped top for bottom, and vice-versa), such as that which may be produced as the result of a standard inversion lens. The inverted image 300A may also result from any odd number of inversions and even number of reflections of the image before encountering the imaging subsystem 100. To allow the pixel data representing the upper-left corner 302 of the image 300A to be transferred first from the imaging subsystem 100 to the remainder of the imaging device, the array 101 is oriented relative to the imaging device so that the upper-left corner 302 is aligned toward the first column 103 of the columns 106 (i.e., the first column 103 is on the left of FIG. 4, since no image reflection is occurring). The array 101 is also configured so that the pixel data is transferred toward the first end 105 of the columns 106 (i.e., toward the bottom of FIG. 4 to adjust to the inversion). Thus, the first shift register 108 receives the pixel data and shifts out the pixel data beginning with the upper-left corner 302 of the image 300A.

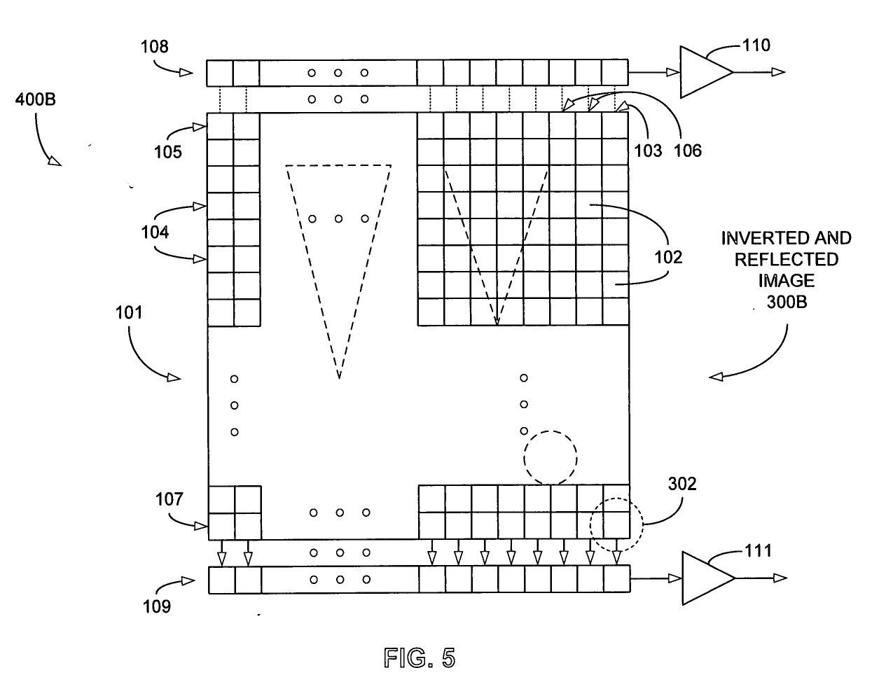

FIG. 5 illustrates an example of a configuration 400B for the imaging system 100 in which the lens utilized in the imaging device produces an inverted (i.e., swapped top for bottom, and vice-versa) and reflected (i.e., swapped left for right, and vice-versa) image 300B. This particular image may be produced by way of an odd number of inversions and an odd number of reflections imposed upon the image 300B. To allow the pixel data for the upper-left corner 302 of the image 300B to be transferred from the imaging subsystem 100 first, the array 101 is oriented relative to the imaging device so that the upper-left corner 302 is aligned toward the first column 103 (i.e., the first column 103 is on the right of FIG. 5 to account for the reflection). The array 101 is also configured so that the pixel data is transferred toward the second end 107 of the columns 106 (i.e., toward the bottom of FIG. 5 to handle the inversion). Thus, the second shift register 109 receives the pixel data and shifts out the pixel data beginning with the upper-left corner 302 of the image 300B.

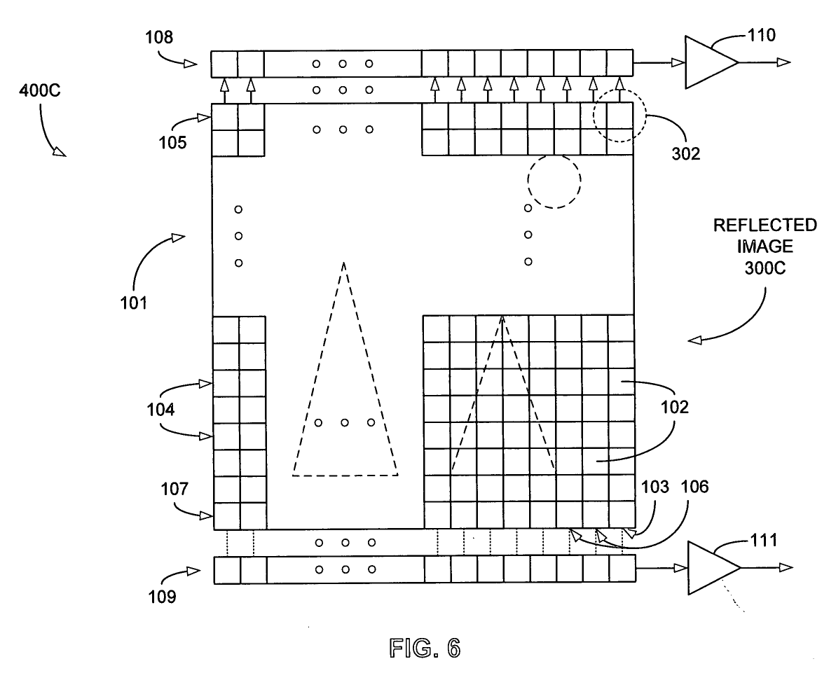

In FIG. 6, the imaging subsystem 100 assumes a configuration 400C compatible with a reflected image 300C, which may result from an even number of inversions and an odd number of reflections of the light being imaged. To allow the pixel data for the upper-left corner 302 of the image 300C to be transferred from the imaging subsystem 100 first, the array 101 is oriented relative to the imaging device so that the upper-left corner 302 is aligned toward the first column 103 (i.e., the first column 103 is on the right of FIG. 6 to account for the reflection). The array 101 is also configured so that the pixel data is transferred toward the first end 105 of the columns 106 (i.e., toward the top of FIG. 6, since no inversion is experienced). Thus, the first shift register 108 receives the pixel data and shifts out the pixel data starting with the upper-left corner 302 of the image 300C.

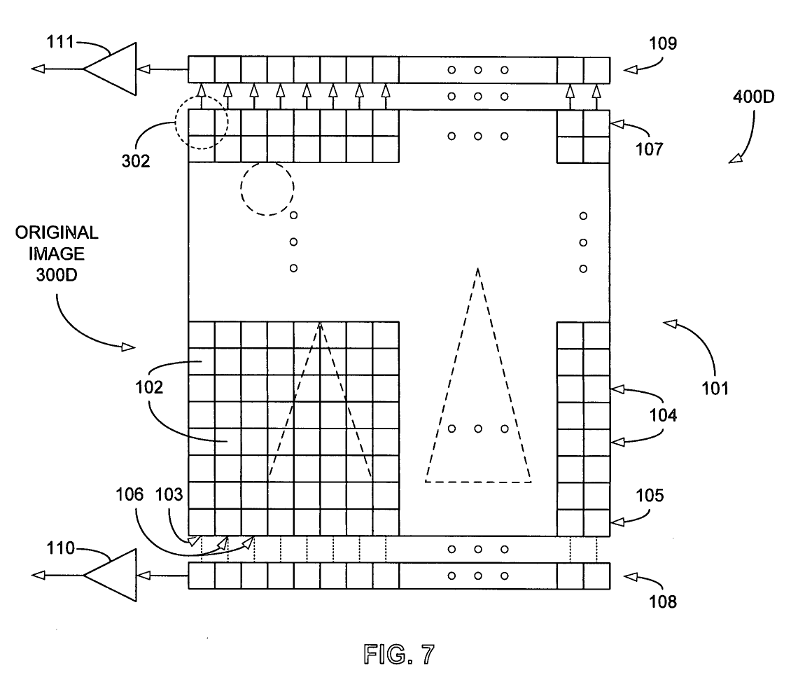

Finally, FIG. 7 illustrates the imaging subsystem 100 when assuming a configuration 400D compatible with a non-inverted, non-reflected image 300D. Such an image may also be produced from an even number of inversions and an even number of reflections of the original image 300. To allow the pixel data for the upper-left corner 302 of the image 300D to be transferred first, the array 101 is oriented relative to the imaging device so that the upper-left corner 302 is aligned toward the first column 103 (i.e., the first column 103 is on the left of FIG. 7 due to the absence of reflection.) The array 101 is configured so that the pixel data is transferred toward the second end 107 of the columns 106 (i.e., toward the top of FIG. 7, since no inversion is taking place). Thus, the second shift register 109 receives the pixel data and shifts out the pixel data beginning with the upper-left corner 302 of the image 300C

In the embodiments discussed above, the array 101 and the shift registers 108, 109 are oriented relative to the imaging device such that the corner of the image 300 selected for first transfer from the imaging subsystem 100 is located near the first column 103. Also, the array 101 is configured to shift the pixel data toward the end of the column associated with the selected corner of the image 300. As a consequence, the shift register 108, 109 closest to the selected corner of the image 300 shifts out pixel data beginning with the selected image corner. With respect to FIGS. 4-7, in imaging devices in which the upper-left corner 302 of the image 300 is to be transferred first, an inversion of the image 300 determines that the pixel data from the columns 106 be transferred toward the bottom, while uninverted images 300 are transferred toward the top. Similarly, a reflection of the image 300 indicates that pixel data within the utilized shift register should be shifted to the right, while a lack of reflection dictates a shift to the left.

Various embodiments of the present invention provide a single imaging subsystem which can assume several configurations for adapting to a variety of lens types which invert and reflect an image any number of times. As mentioned above, some newer imaging devices currently utilize reflection or mirror lenses in lieu of simple inversion lenses to extend the effective local length of the device without increasing the size of the device. To this end, the reflection lens normally includes one or more mirrors to bend or fold the optical path of the received light within the device prior to the light encountering the array of imaging pixels. In so doing, however, the image is likely to be oriented relative to the array differently from that identified with a simple inversion lens, due to any number of inversions and/or reflections of the image resulting from the lens. Employing the configurations shown herein, the imaging subsystem allows a selectable order of transfer of the generated pixel data from the imaging subsystem for use by the remainder of the associated imaging device. In many cases, this order reduces or eliminates reordering of the image prior to subsequent processing by the device, thus conserving processing bandwidth and other resources of the imaging device that may be utilized for other tasks.

While several embodiments of the invention have been discussed herein, other embodiments encompassed by the scope of the invention are possible. For example, while some embodiments of the invention are described above in conjunction with primarily consumer-oriented applications, such as digital still and video cameras, other types of imaging equipment designed substantially for industrial, scientific, commercial and other markets may also benefit from application or adaptation of the various embodiments, as presented above. Also, while many directional references are made herein (e.g., left, right, upper, lower, and so on), these references are provided merely as an aid to understanding the specific embodiments described herein, and thus do not limit or prohibit the use of other embodiments utilizing differing directional reference frames. Further, aspects of one embodiment may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims.

What is claimed is:

1. An imaging subsystem comprising:
imaging pixels arranged in an array comprising rows and columns, wherein each imaging pixel is configured to generate pixel data corresponding to a portion of an image and transfer the pixel data toward a first end or a second end of its column;
a first shift register configured to receive the pixel data from the first end of the columns and shift the pixel data toward a first direction associated with a first of the columns; and
a second shift register configured to receive the pixel data from the second end of the columns and shift the pixel data toward the first direction.

2. The imaging subsystem of claim 1, wherein the imaging pixels comprise photocells of a charge coupled device.

3. The imaging subsystem of claim 1, wherein each of the pixel data comprises electrical charge related to an intensity of light received by the corresponding imaging pixel.

4. The imaging subsystem of claim 1, further comprising:
a first amplifier configured to amplify the pixel data shifted from the first shift register; and
a second amplifier configured to amplify the pixel data shifted from the second shift register.

5. The imaging subsystem of claim 1, wherein:
the array is oriented relative to the image such that a selected corner of the image is located near the first of the columns; and
the array is configured so that the pixel data is shifted toward the first end of the columns, wherein the selected corner of the image is located near the first end of the columns;
whereby the first shift register is configured to shift the pixel data from the first shift register beginning with the selected corner of the image.

6. The imaging subsystem of claim 5, wherein the selected corner of the image is the upper-left corner of the image.

7. The imaging subsystem of claim 1, wherein:
the array is oriented relative to the image such that a selected corner of the image is located near the first of the columns; and
the array is configured so that the pixel data is shifted toward the second end of the columns, wherein the selected corner of the image is located near the second end of the columns;
whereby the second shift register is configured to shift the pixel data from the second shift register beginning with the selected corner of the image.

8. The imaging subsystem of claim 7, wherein the selected corner of the image is the upper-left corner of the image.

9. A digital still camera comprising the imaging subsystem of claim 1.

10. A digital video camera comprising the imaging subsystem of claim 1.

11. A digital image scanner comprising the imaging subsystem of claim 1.

12. A method of supplying an imaging subsystem for an imaging device, the method comprising:
providing an array comprising imaging pixels arranged in rows and columns, wherein each imaging pixel is configured to generate pixel data corresponding to a portion of an image and transfer the pixel data toward a first end or a second end of its column;
providing a first shift register configured to receive the pixel data from the first end of the columns and shift the pixel data toward a first direction associated with a first of the columns;
providing a second shift register configured to receive the pixel data from the second end of the columns and shift the pixel data toward the first direction; and
orienting the array relative to the imaging device so that a selected corner of the image is located toward the first of the columns.

13. The method of claim 12, further comprising configuring the array so that the pixel data is shifted toward the end of the columns associated with the selected corner of the image.

14. The method of claim 12, wherein the selected corner of the image is the upper-left corner of the image.

15. The method of claim 12, wherein the imaging pixels comprise photocells of a charge coupled device.

16. The method of claim 12, wherein each of the pixel data comprises electrical charge related to an intensity of light received by the corresponding imaging pixel.

17. The method of claim 12, wherein the imaging device comprises a digital still camera.

18. The method of claim 12, wherein the imaging device comprises a digital video camera.

19. The method of claim 12, wherein the imaging device comprises a digital image scanner.

20. An imaging subsystem comprising:
means for generating pixel data, wherein each of the pixel data corresponds to one of a plurality of portions of an image, and wherein the portions are organized in rows and columns;
first means for receiving the pixel data from the generating means by row beginning with a first end of the columns and shifting the pixel data toward a first direction associated with a first of the columns; and
second means for receiving the pixel data from the generating means by row beginning with a second end of the columns and shifting the pixel data toward the first direction.

21. The imaging subsystem of claim 20, wherein the generating means comprises photocells of a charge coupled device.

22. The imaging subsystem of claim 20, wherein each of the pixel data comprises electrical charge related to an intensity of light associated with the corresponding portion of the image.

23. The imaging subsystem of claim 20, further comprising:
first means for amplifying the pixel data shifted from the first receiving and shifting means; and
second means for amplifying the pixel data shifted from the second receiving and shifting means.

24. The imaging subsystem of claim 20, wherein:
the generating means is oriented relative to the image such that a selected corner of the image is located near the first of the columns; and
the generating means is configured so that the pixel data are shifted toward the first end of the columns, wherein the selected corner of the image is located near the first end of the columns;
whereby the first receiving and shifting means is configured to shift the pixel data from the first receiving and shifting means beginning with the selected corner of the image.

25. The imaging subsystem of claim 20, wherein:
the generating means is oriented relative to the image such that a selected corner of the image is located near the first of the columns; and
the generating means is configured so that the pixel data are shifted toward the second end of the columns, wherein the selected corner of the image is located near the second end of the columns;
whereby the second receiving and shifting means is configured to shift the pixel data from the second receiving and shifting means beginning with the selected corner of the image.

26. A digital still camera comprising the imaging subsystem of claim 20.

27. A digital video camera comprising the imaging subsystem of claim 20.

28. A digital image scanner comprising the imaging subsystem of claim 20.
